(19) United States
(12) Patent Application Publication
(10) Pub. No.: US 2020/0117545 A1
(43) Pub. Date: Apr. 16, 2020

(54) METHOD, DEVICE AND COMPUTER PROGRAM PRODUCT FOR BACKUPING VIRTUAL MACHINE

(71) Applicant: EMC IP Holding Company LLC, Hopkinton, MA (US)

(72) Inventors: Jie Liu, Chengdu (CN); Ying Li, Chengdu (CN); Ningping Gou, Chengdu (CN)

(21) Appl. No.: 16/291,025

(22) Filed: Mar. 4, 2019

(30) Foreign Application Priority Data
Oct. 12, 2018 (CN) 201811247622.9

(51) Int. Cl. G06F 11/14; G06F 9/455; G06F 16/11

(52) U.S. Cl. CPC G06F 11/1451; G06F 9/45558; G06F 2201/84; G06F 2009/45583; G06F 16/128

(57) ABSTRACT

Embodiments of the present disclosure relate to a method, device, and computer program product for backing up a virtual machine. In one embodiment, the method includes obtaining a first file path in a first operating system installed on a virtual machine, wherein the virtual machine executes on a second operating system. The method further includes determining a second file path in the second operating system corresponding to the first file path based on the first file path and backing up one or more files in the virtual machine based on the second file path.

### FIELD

Embodiments of the present disclosure generally relate to the field of storage and backup, and more particularly to a method, device, and computer program product for backing up a virtual machine.

### BACKGROUND

Data backup refers to backing up data to other storage devices, and data may be recovered through backup to avoid unnecessary loss of data when a data failure or disaster occurs. The backup types of data backup may be classified into full backup, incremental backup, differential backup, and selective backup. Data backup may be classified into hot backup and cold backup depending on whether the system is in a normal operation state.

A virtual machine is a complete computer system which is simulated through software, has complete hardware software functions and runs in a fully isolated environment. Through virtualization software, a user may simulate one or more virtual machines on a single physical computer. The computer hardware resource become a detachable resource through virtualization technology, and the detached resources form a virtual machine, which possesses service capabilities provided by the original hardware. For example, it is possible to install one operating system on another operating system, which enables the computer to run both operating systems simultaneously. The virtual machine may be used for software development and test, and be widely used in the server industry.

### SUMMARY

Embodiments of the present disclosure provide a method, device, and computer program product for backing up a virtual machine.

In one aspect of the disclosure, there is provided a method for backing up a virtual machine. The method comprises obtaining a first file path in a first operating system installed on a virtual machine, wherein the virtual machine runs on a second operating system. The method further comprises determining a second file path in the second operating system corresponding to the first file path based on the first file path, and backing up a file in the virtual machine based on the second file path.

According to another aspect of the present disclosure, there is provided a device for backing up a virtual machine. The device comprises a processing unit and a memory coupled to the processing unit and storing instructions thereon. The instructions, when executed by the processing unit, perform the acts comprising obtaining a first file path in a first operating system installed on a virtual machine, wherein the virtual machine runs on a second operating system. The acts further comprises determining a second file path in the second operating system corresponding to the first file path based on the first file path and backing up a file in the virtual machine based on the second file path.

According to a further aspect of the present disclosure, there is provided a computer program product that is tangibly stored on a non-transient computer readable medium and includes machine-executable instructions. The machine-executable instructions, when executed, cause a computer to execute the method or process according to embodiments of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of embodiments of the present disclosure will be made more apparent by describing the present disclosure in more detail with reference to figures. In the figures, the same or like reference signs represent the same or like elements.

FIG. 1 illustrates a schematic diagram of an architecture for backing up a virtual machine according to an embodiment of the present disclosure.

FIG. 2 illustrates a flow chart of a method for backing up a virtual machine according to an embodiment of the present disclosure.

FIG. 3 illustrates a flow chart of a method for determining a partition corresponding to a drive letter according to an embodiment of the present disclosure.

FIG. 4 illustrates a schematic diagram of a Master File Table (MFT) file record according to an embodiment of the present disclosure.

FIG. 5 illustrates a schematic diagram of a GUID Partition Table (GPT) according to an embodiment of the present disclosure.

FIG. 6 illustrates a schematic block diagram of a device adapted to implement an embodiment of the present disclosure.

### DETAILED DESCRIPTION OF EMBODIMENTS

Preferred embodiments of the present disclosure will be described below in more detail with reference to figures. Although figures show preferred embodiments of the present disclosure, it should be appreciated that the present disclosure may be implemented in various forms and should not be limited by embodiments stated herein. On the contrary, these embodiments are provided to make the present disclosure more apparent and complete, and to convey the scope of the present disclosure entirely to those skilled in the art.

As used herein, the term “includes” and its variants are to be read as open terms that mean “includes, but is not limited to.” Unless otherwise specified, the term “or” represents “and/or”. The term “based on” is to be read as “based at least in part on.” The term “an implementation” is to be read as “at least one implementation.” The term “another implementation” is to be read as “at least one other implementation.” Terms “first” and “second” may refer to different or identical objects, unless otherwise it is explicitly specified that they refer to different objects.

Generally, a virtual machine may be installed on a real operating system, and then a virtual operating system may execute in the virtual machine. Because the virtual operating system is a closed, complete system, the application or software executing in the real operating system cannot obtain a real path of the path specified by the user in the virtual operating system. Therefore, it is usually only possible to use a full backup mode for the virtual machine, and typically not possible to implement partial backup of the virtual machine. If the user needs to exclude the backup or only backup a specified path in the virtual machine, the traditional solution cannot be implemented. On the contrary, the traditional methods can only perform the full backup, which typically wastes storage space and network bandwidth.

To this end, embodiments of the present disclosure propose a new scheme for backing up a virtual machine. Embodiments of the present disclosure may exclude and/or reserve a user-specified folder or file during virtual machine backup by mapping a file path in the virtual machine to a file path in the real operating system, thereby saving storage space and network bandwidth. Thus, in accordance with embodiments of the present disclosure, the scenarios of data backup are greatly expanded, and the user may specify to exclude backing up and/or only backup certain paths and/or files in the virtual machine.

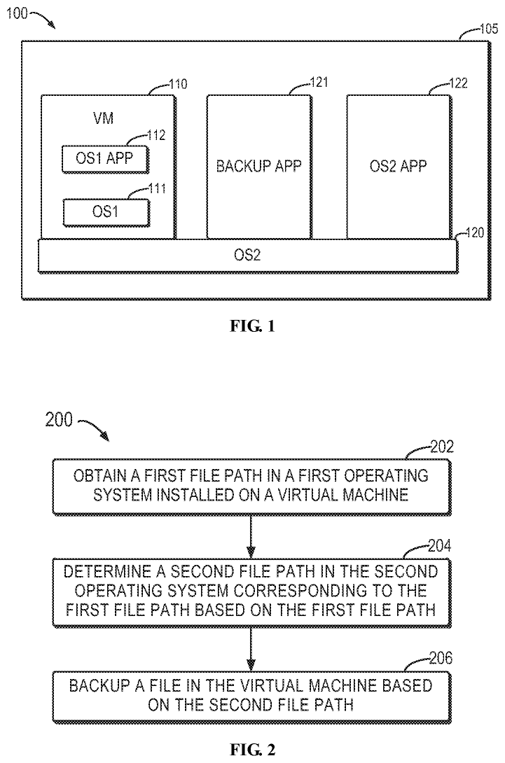

The basic principles and several example implementations of the present disclosure are described below with reference to FIG. 1 through FIG. 6. It should be appreciated that these example embodiments are given only to enable those skilled in the art to better understand and thereby implement embodiments of the present disclosure, not to limit the scope of the present disclosure in any manner.

FIG. 1 illustrates a schematic diagram of architecture 100 for backing up a virtual machine according to an embodiment of the present disclosure. As shown in FIG. 1, on a computing device 105, the virtual machine (VM) 110 is running on a real operating system 120 (referred to as “a second operating system”, simply called as OS2), wherein an operating system 111 (referred to as “a first operating system”, simply called as OS1) is installed in the virtual machine 110. It should be appreciated that the operating system 120 and the operating system 111 are usually different types of operating systems. For example, the operating system 120 may be a Linux-based operating system while the operating system 111 may be a Windows operating system. In this manner, two different types of operating systems may be simultaneously supported on the computing device 105 in a virtualized manner. However, the operating system 120 and the operating system 111 may also be other operating systems or may be the same operating system. In addition, the user device 105 may be a commonly used computer, a dedicated server, or the like.

Referring to FIG. 1, a backup application 121, which may be a software application for data backup and recovery, may also be executing on the operating system 120. In addition, an OS2 application 122 dedicated to the operating system 120 may also be executing on the operating system 120. Accordingly, an OS1 application 112 dedicated to the operating system 111 may be executing on the operating system 111. In this manner, multiple types of applications (such as applications 122 and 112) that are based on different operating system platforms may be running on computing device 105.

Because the backup application 121 runs on the operating system 120, it does not understand the meaning of the drive letter (e.g., “D:”) in the virtual operating system 111. Thus, embodiments of the present disclosure may map drive letters in the virtual operating system to the real operating system by mapping file paths of two operating systems. In general, the backup application 121 may use a Master File Table (MFT) of the New Technology File System (NTFS) to locate a logical cluster number (LCN), a virtual cluster number (VCN), and length of the file. For files that need to be excluded from backup, the backup application 121 will bypass the blocks of these files when backing up.

FIG. 2 illustrates a flow chart of a method 200 for backing up a virtual machine according to an embodiment of the present disclosure. It should be understood that the method 200 may be performed by the computing device 105 as described above with respect to FIG. 1.

At 202, a first file path in the first operating system installed on the virtual machine is obtained, and the virtual machine runs on the second operating system. For example, the backup application 121 may obtain a user-specified path in the operating system 111 installed on the virtual machine 110, for example, a user may enter a path “d:\logs” in the backup application 121, which may be used to indicate that the user wants to exclude backup of files in this file path, or the user only needs to backup the files in this file path.

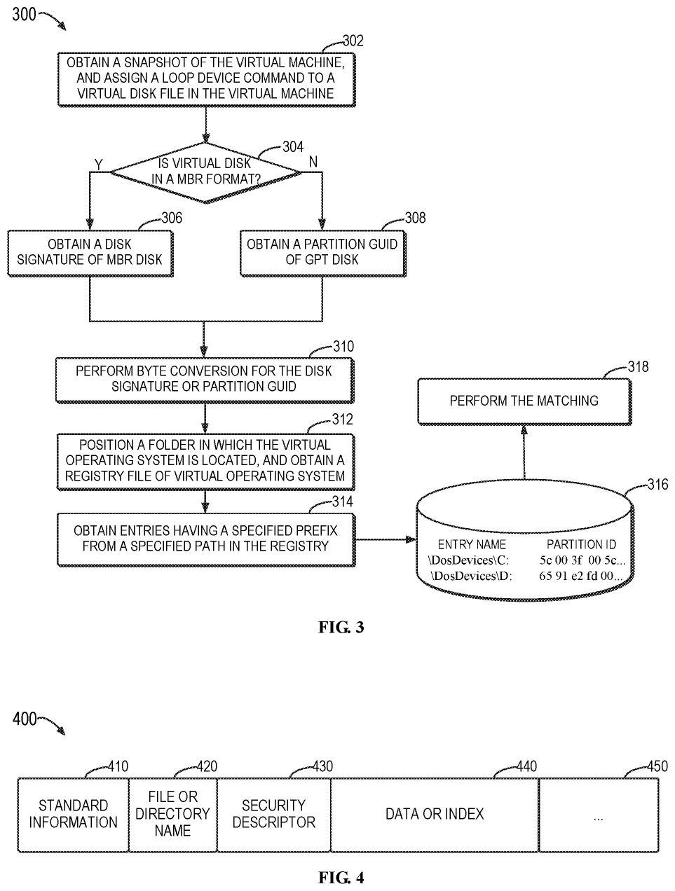

At 204, a second file path in the second operating system corresponding to the first file path is determined based on the first file path. For example, it is possible to map the file path “d:\logs” in the virtual operating system 111 to a corresponding partition or path in the real operating system 120, and after determining the partition corresponding to the drive letter “d:”, the real path corresponding to the file path “d:\logs” can be determined. An example implementation about how to determine a partition corresponding to a drive letter is described below with reference to FIG. 3.

At 206, one or more files in the virtual machine is backed up based on the second file path. After obtaining the corresponding second file path, the backup application 121 may perform a corresponding virtual machine backup action. For example, the backup application 121 may exclude from the backup the contents in the backup file path “d:\logs”. In some embodiments, the backup application 121 may determine one or more file paths that the user wants to backup and/or one or more file paths that the user does not want to backup, and then perform the corresponding virtual machine backup process.

Thus, embodiments of the present disclosure can exclude and/or reserve a user-specified folder or file during the backup of virtual machine by mapping the file path in the virtual machine to the file path in the real operating system, thereby saving the storage space and network bandwidth. By contrast, the traditional backup systems may at most only exclude some files in the root path, but cannot exclude backup of contents in the user-specified file path of virtual machine.

FIG. 3 illustrates a flow chart of a method 300 for determining a partition corresponding to a drive letter according to an embodiment of the present disclosure. It should be understood that the method 300 may be performed by the computing device 105 as described above with respect to FIG. 1, and further the method 300 may be an example implementation of the action 204 as described above with respect to FIG. 2.

At 302, after a snapshot is created for the virtual machine 110, a virtual machine tool is used to install the virtual snapshot in the backup application 121, and then a loop device command is assigned to a virtual disk (VMDK) file in the virtual machine 110, such that the backup application 121 can operate the virtual disk file like operating a block device. The VMDK is a virtual hard format created by the virtual machine. The file exists in the virtual file system and is called VMFS (Virtual Machine File System). One VMDK file usually represents a physical hard drive of VMFS on the virtual machine. All user data and configuration information related to the virtual server are stored in the VMDK file.

At 304, a partition table format of the virtual disk is determined. If the partition table is in the Master Boot Record (MBR) format, a disk signature of the MBR disk is obtained at 306, which is usually located at offset 440 of a first sector. If the partition table is in the GUID Partition Table (GPT) format, a second sector of the GPT disk is obtained 308 to find GPT header information to obtain the partition summary information. Then, based on the partition summary information, the corresponding offset is jumped to the related partition to get the unique partition GUID at offset 16.

For example, FIG. 5 shows a diagram 500 of a GPT according to an embodiment of the present application, where each logic block may be 512 bytes in size, each partition entry is 128 bytes, and the corresponding partition entry is assumed to be located in Logical Block Addressing (LBA) 2-33, the protected MBR is located in LBA 0, the primary GPT header information is in LBA 1, the GPT header has a pointer to the partition table, and LBA 34 is the first available sector on the disk. Furthermore, as opposed to the main GPT, there is also a secondary GPT starting from the ending of the volume and using an LBA with a “—” mark. Accordingly, corresponding partition identifier information may be obtained for the MBR disk and the GPT disk at 306 and 308, respectively.

MBR is a boot code located at the forefront of a disk, it is responsible for discriminating the legality of the partition and positioning the partition boot information when the disk operating system reads from and writes to the disk, and it is generated by the disk operating system when the hard disk is initialized. GPT is a structural layout standard of a hard disk partition table, it is a part of an Extensible Firmware Interface (EFI) standard and is used to replace 32 bits in the BIOS system to store the Master Boot Record (MBR) Partition Table of the logic block address and size information.

Returning to FIG. 3, at 310, it is possible to perform byte conversion for the disk signature or partition GUID, for example the disk signature or partition GUID in a little-endian byte order is converted into a big-endian byte order for byte conversion across operating systems.

At 312, the folder in which the virtual operating system is located, and a registry file of the virtual operating system is obtained from the folder. For example, NTFS MFT is searched and a folder that includes the virtual operating system is searched. For example, for a Windows virtual operating system, it is possible to first attempt to search for “windows”, “winnt”, “Windows”, etc. If not found, it is possible to search for “bootstat.dat” at the root level, which is specific to one file of the Windows operating system. After the folder in which the Windows operating system is located, the registry file is obtained from the folder. FIG. 4 illustrates a schematic diagram 400 of a MFT file record according to an embodiment of the present disclosure, including standard information 410, file or directory name 420, security descriptor 430, data or index 440, and other information 450. This structure is especially advantageous for small files or directories (usually less than 512 bytes), and the data may be directly and completely contained in the MFT table, thereby making the access to the file faster.

It should be appreciated that although the embodiment of the present disclosure is described with the Windows operating system as the virtual first operating system. However, the first operating system may also be another operating system. In addition, specific information specific to other operating systems may be used to locate the folder of this operating system in another operating system.

The registry is the core database of the Windows operating system, and it stores various parameters and directly controls the startup of Windows, the loading of hardware drivers, and the running of some Windows applications. Returning to FIG. 3, at 314, one or more entries having a specified prefix are obtained from a specified path in the registry. For example, the registry file is opened and the information is obtained from the “HKLM\SYSTEM\MountedDevices” or “HKEY_LOCAL_MACHINE\SYSTEM\MountedDevices” file, and all entries starting with “\DosDevices\” are obtained, for example, “\DosDevices\D:” represents the assigned drive letter

The obtained entries having the specified prefix may be stored or cached as a repository or dictionary 316, with multiple entries in the dictionary 316, each entry includes a drive letter and a corresponding identifier. In some embodiments, each entry has a key-value pair, the key in the key-value pair includes a specified prefix and a drive letter in the file path of the virtual operating system, such as “\DosDevices\D:”, and the value in the value key-value pair includes a partition identifier such as “65 91 e2 fd 00 . . . ”.

Next, at 318, matching between the disk signature or partition GUID and the entries in the dictionary 316 may be performed. For example, for an MBR disc, its disk signature+partition start offset is used to match with the partition identifier in the dictionary 316, and the actual partition corresponding to the MBR drive letter in the virtual machine may be determined. For another example, for a GPT disk, the prefix 444d494f3a49443a+ partition GUID may be used to match with the partition identifier in the dictionary 316, so that the actual partition corresponding to the GPT drive letter in the virtual machine may be determined. After determining the actual partition corresponding to the drive letter in the virtual machine, the actual file path corresponding to the virtual file path may be determined, thereby implementing the function of partial backup for the virtual machine.

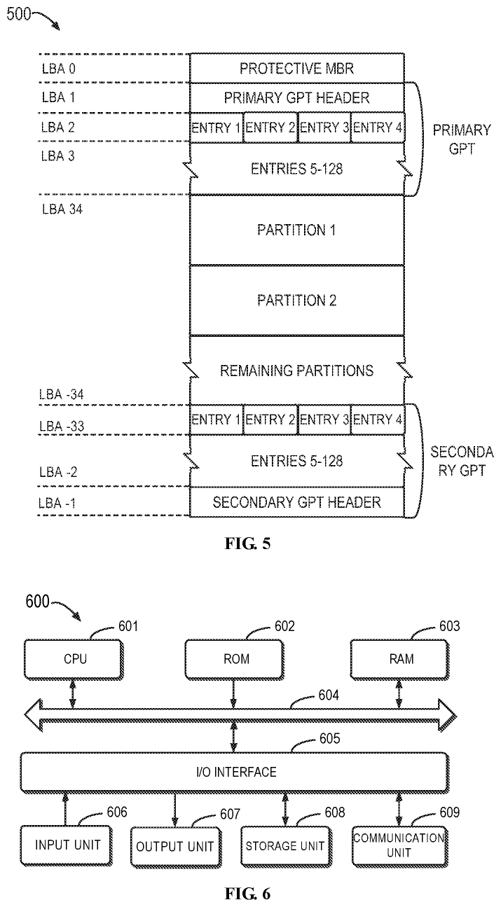

FIG. 6 illustrates a block diagram of a device 600 adapted to implement an embodiment of the present disclosure. The device may be the computing device 105 described with reference to FIG. 1. As shown in the figure, the device 600 comprises a central processing unit (CPU) 601 that may perform various appropriate actions and processing based on computer program instructions stored in a read-only memory (ROM) 602 or computer program instructions loaded from a storage unit 608 to a random access memory (RAM) 603. In the RAM 603, there further store various programs and data needed for operations of the device 600. The CPU 601, ROM 602 and RAM 603 are connected to each other via a bus 604. An input/output (I/O) interface 605 is also connected to the bus 604.

Various components in the device 600 are connected to the I/O interface 605, including: an input 606 such as a keyboard, a mouse and the like; an output unit 607 including various kinds of displays and a loudspeaker, etc.; a storage unit 608 including a magnetic disk, an optical disk, and etc.; a communication unit 609 including a network card, a modem, and a wireless communication transceiver, etc. The communication unit 609 allows the device 600 to exchange information/data with other devices through a computer network such as the Internet and/or various kinds of telecommunications networks.

Various processes and processing described above may be executed by the processing unit 601. For example, in some embodiments, the method may be implemented as a computer software program that is tangibly embodied on a machine readable medium, e.g., the storage unit 608. In some embodiments, a part or all of the computer programs may be loaded and/or mounted onto the device 600 via ROM 602 and/or communication unit 609. When the computer program is loaded to the RAM 603 and executed by the CPU 601, one or more steps of the method as described above may be executed.

In some embodiments, the method 200 described above may be implemented as a computer program product. The computer program product may include a computer readable storage medium which carries computer readable program instructions for executing aspects of the present disclosure.

The computer readable storage medium can be a tangible device that can reserve and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for backing up a virtual machine comprising:
obtaining a first file path in a first operating system installed on a virtual machine, the virtual machine executing on a second operating system;
determining, based on the first file path, a second file path in the second operating system corresponding to the first file path; and
backing up a file in the virtual machine based on the second file path.

2. The method according to claim 1, wherein the first file path is a user-specified path, and backing up the file in the virtual machine comprises:
backing up files in file paths in the virtual machine except for the first file path.

3. The method according to claim 1, wherein the determining the second file path in the second operating system corresponding to the first file path comprises:
locating, in the second operating system, a folder in which the first operating system is located; and
obtaining a registry file of the first operating system from the folder.

4. The method according to claim 3, wherein the locating in the second operating system the folder in which the first operating system is located comprises:
locating, by searching for information specific to the first operating system, the folder in which the first operating system is located.

5. The method according to claim 3, wherein the determining the second file path in the second operating system corresponding to the first file path further comprises:
obtaining a plurality of entries having a specified prefix from a specified path in the registry, wherein an entry of the plurality of entries comprising a pair of a key and a value, the key comprising the specified prefix and a drive letter, and the value comprising a partition identifier; and
determining the second file path based on the plurality of entries.

6. The method according to claim 5, wherein the determining the second file path based on the plurality of entries comprises:
obtaining a disk signature of the virtual disk; and
determining the second file path based on the disk signature and the plurality of entries.

7. The method according to claim 5, wherein the determining the second file path based on the plurality of entries comprises:
obtaining a partition globally unique identifier (GUID) of the virtual disk; and
determining the second file path based on the partition GUID and the plurality of entries.

8. The method according to claim 1, further comprising:
obtaining a snapshot of the virtual machine before determining the second file path; and
assigning a command for a loop device to a virtual disk file in the virtual machine.

9. A device for backing up a virtual machine comprising:
a processing unit; and
a memory coupled to the processing unit and storing instructions thereon, the instructions, when executed by the processing unit, perform a method, the method comprising:
obtaining a first file path in a first operating system installed on a virtual machine, the virtual machine executing on a second operating system;
determining, based on the first file path, a second file path in the second operating system corresponding to the first file path; and
backing up a file in the virtual machine based on the second file path.

10. The device according to claim 9, wherein the first file path is a user-specified path, and backing up the file in the virtual machine comprises:
backing up files in file paths in the virtual machine except for the first file path.

11. The device according to claim 9, wherein the determining the second file path in the second operating system corresponding to the first file path comprises:
locating, in the second operating system, a folder in which the first operating system is located; and
obtaining a registry file of the first operating system from the folder.

12. The device according to claim 11, wherein the locating in the second operating system the folder in which the first operating system is located comprises:
locating, by searching for information specific to the first operating system, the folder in which the first operating system is located.

13. The device according to claim 11, wherein the determining the second file path in the second operating system corresponding to the first file path further comprises:
obtaining a plurality of entries having a specified prefix from a specified path in the registry, wherein an entry of the plurality of entries comprising a pair of a key and a value, the key comprising the specified prefix and a drive letter, and the value comprising a partition identifier; and
determining the second file path based on the plurality of entries.

14. The device according to claim 13, wherein the determining the second file path based on the plurality of entries comprises:
obtaining a disk signature of the virtual disk; and
determining the second file path based on the disk signature and the plurality of entries.

15. The device according to claim 13, wherein the determining the second file path based on the plurality of entries comprises:
obtaining a partition globally unique identifier (GUID) of the virtual disk; and
determining the second file path based on the partition GUID and the plurality of entries.

16. The device according to claim 9, the method further comprises:
obtaining a snapshot of the virtual machine before determining the second file path; and
assigning a command for a loop device to a virtual disk file in the virtual machine.

17. A computer program product that is tangibly stored on a non-transient computer readable medium and includes machine-executable instructions, the machine-executable instructions, when executed, causing a computer to execute a method, the method comprising:
obtaining a first file path in a first operating system installed on a virtual machine, the virtual machine executing on a second operating system;
determining, based on the first file path, a second file path in the second operating system corresponding to the first file path; and
backing up a file in the virtual machine based on the second file path.

18. The computer program product of claim 17, wherein the first file path is a user-specified path, and backing up the file in the virtual machine comprises:
backing up files in file paths in the virtual machine except for the first file path.

19. The computer program product of claim 17, wherein the determining the second file path in the second operating system corresponding to the first file path comprises:
locating, in the second operating system, a folder in which the first operating system is located; and
obtaining a registry file of the first operating system from the folder.

20. The computer program product of claim 19, wherein the determining the second file path in the second operating system corresponding to the first file path further comprises:
obtaining a plurality of entries having a specified prefix from a specified path in the registry, wherein an entry of the plurality of entries comprising a pair of a key and a value, the key comprising the specified prefix and a drive letter, and the value comprising a partition identifier; and
determining the second file path based on the plurality of entries.
